(19) United States
(12) Patent Application Publication
(10) Pub. No.: US 2026/0320918 A1
(43) Pub. Date: Oct. 15, 2026

(54) THREE-DIMENSIONAL VIRTUAL GARMENT SEWING SIMULATION WITH ADJUSTABLE MESH PROPERTIES

(71) Applicant: CLO Virtual Fashion Inc., Seoul (KR)

(72) Inventor: In Yong JEON, Seoul (KR)

(21) Appl. No.: 19/693,685

(22) Filed: Jun. 1, 2026

Related U.S. Application Data
(63) Continuation of application No. PCT/KR2023/020647, filed on Dec. 14, 2023.

(30) Foreign Application Priority Data
Dec. 13, 2023 (KR) 10-2023-0180585

(51) Int. Cl. G06T 17/20

(52) U.S. Cl. CPC G06T 17/205; G06T 2200/24; G06T 2210/16

(57) ABSTRACT

The following disclosure relates to a sewing simulation method including receiving a first selection input for a sewing line between patterns in a three-dimensional (3D) virtual garment, receiving a second selection input for at least one of ease sewing and stretch sewing for the sewing line, adjusting mesh properties of a sewing area adjacent to the sewing line, based on the second selection input, and simulating the 3D virtual garment to which the adjusted mesh properties are applied.

### CROSS-REFERENCE TO RELATED APPLICATIONS

This is a bypass continuation of International PCT Application No. PCT/KR2023/020647, filed on Dec. 14, 2023, which claims priority to Republic of Korea Patent Application No. 10-2023-0180585, filed on Dec. 13, 2023, which is incorporated by reference herein in their entirety.

### TECHNICAL FIELD

The following embodiments relate to a method and apparatus for a sewing simulation of garment patterns.

### BACKGROUND ART

When a garment is worn by a person, it may appear to be three-dimensional, but in reality, it is closer to two-dimensional because a garment is a combination of pieces of fabric cut according to a two-dimensional pattern. Since fabric used as the material for a garment is flexible, its shape may change in various ways depending on a shape or movement of a person wearing the garment or a sewing method.

In general, in order to express wrinkles that give realism to a garment, sewing relationships of pattern pieces of the garment are simulated together. For example, each part of a garment has a different sewing method, and the shape of the wrinkles that are expressed is different depending on the sewing method. Therefore, a simulation method may be required to realistically express the sewing relationships.

### SUMMARY

A three-dimensional (3D) virtual garment simulation method according to an embodiment includes receiving a first selection input of a user for a sewing line between patterns in a 3D virtual garment, receiving a second selection input of the user for at least one of ease sewing and stretch sewing for the sewing line, adjusting mesh properties of a sewing area adjacent to the sewing line, based on the second selection input of the user, and simulating the 3D virtual garment to which the adjusted mesh properties are applied.

The adjusting of the mesh properties may include inserting one or more virtual springs into a sewing area of at least one pattern among the patterns in the sewing area.

The virtual spring may be adjusted in ratio or stiffness in response to a third selection input of the user.

The sewing area adjacent to the sewing line may be an area in which properties of polygons adjacent to the virtual spring among polygons included in the mesh change as the ratio or stiffness of the virtual spring is adjusted.

The ease sewing may be a sewing that inserts the virtual spring or provides elasticity to a sewing area of a pattern including a short sewing line so that a length of the sewing line is biased to a length of the short sewing line among the patterns.

The adjusting of the mesh properties may include when a selection input for the ease sewing is received in the second selection input of the user, in response to a change in properties of polygons of the sewing area of the pattern including the short sewing line among the patterns, changing properties of polygons of a sewing area of remaining patterns among the patterns.

The stretch sewing may be a sewing that inserts the virtual spring or provides elasticity to a sewing area of a pattern including a long sewing line so that a length of the sewing line is biased to a length of the long sewing line among the patterns.

The adjusting of the mesh properties may include when a selection input for the stretch sewing is received in the second selection input of the user, in response to a change in properties of polygons of the sewing area of the pattern including the long sewing line, changing properties of polygons of a sewing area of remaining patterns among the patterns.

The 3D virtual garment simulation method may further include displaying a property editor interface for adjusting properties of the sewing line in response to receiving the first selection input of the user for the sewing line.

The 3D virtual garment simulation method may further include displaying, on the property editor interface, an interface for receiving the second selection input of the user for at least one of the ease sewing and the stretch sewing and an interface for receiving an adjustment input for a ratio or stiffness of a virtual spring, and displaying a sewing area adjacent to the sewing line in response to the second selection input of the user and the adjustment input for the ratio or stiffness of the virtual spring.

The 3D virtual garment simulation method may further include receiving a fourth selection input of the user and generating a notch in the sewing line, and receiving a sewing generation input of the user for the sewing line using the ease sewing or the stretch sewing, based on the notch.

The 3D virtual garment simulation method may further include in response to receiving the sewing generation input, generating a combination of the ease sewing or the stretch sewing on the sewing line based on a position of the notch generated on the sewing line.

A simulation apparatus according to an embodiment includes memory including instructions, an output device displaying a user interface, and a processor configured to receive a first selection input of a user for a sewing line between patterns in a 3D virtual garment, receive a second selection input of the user for at least one of ease sewing and stretch sewing for the sewing line, adjust mesh properties of a sewing area adjacent to the sewing line, based on the second selection input of the user, and simulate the 3D virtual garment to which the adjusted mesh properties are applied.

A server according to an embodiment includes a communication unit configured to receive an input from a terminal for performing a sewing simulation and transmit a result of the performing of the sewing simulation, memory including instructions, and a processor configured to receive a first selection input of a user for a sewing line between patterns in a 3D virtual garment, receive a second selection input of the user for at least one of ease sewing and stretch sewing for the sewing line, adjust mesh properties of a sewing area adjacent to the sewing line, based on the second selection input of the user, and simulate the 3D virtual garment to which the adjusted mesh properties are applied.

### BRIEF DESCRIPTION OF DRAWINGS

FIG. 1 is a flowchart illustrating a sewing simulation method according to an embodiment.

FIG. 2 is a diagram schematically illustrating a mesh according to an embodiment.

FIGS. 3 to 5B are schematic diagrams illustrating a sewing method according to an embodiment.

FIGS. 6A and 6B are diagrams schematically illustrating sewing simulations according to an embodiment.

FIGS. 7A and 7B are diagrams schematically illustrating sewing simulations according to an embodiment.

FIGS. 8A and 8B are diagrams schematically illustrating a user interface according to an embodiment.

FIG. 9 is a block diagram of an electronic device according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

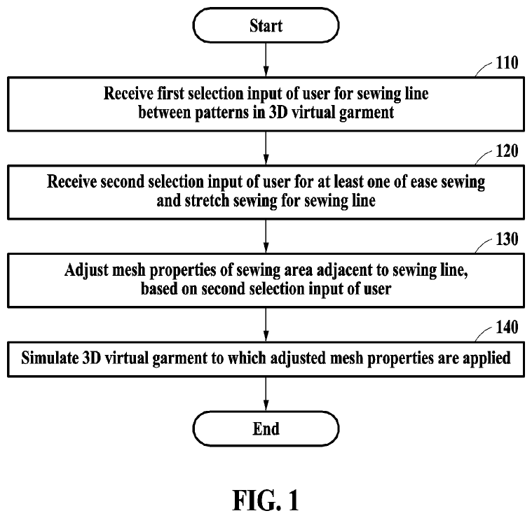

FIG. 1 is a flowchart illustrating a sewing simulation method according to an embodiment.

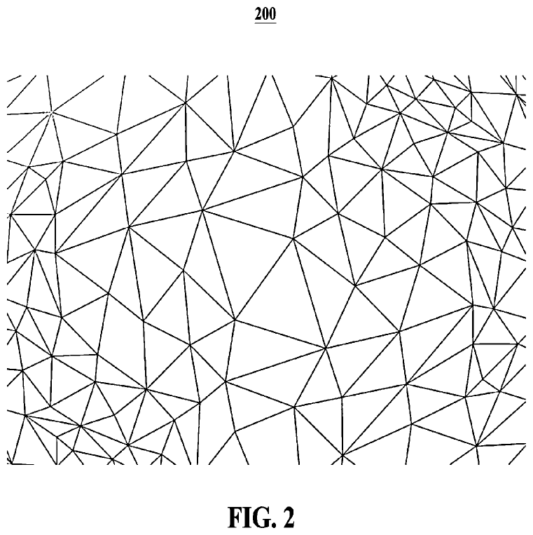

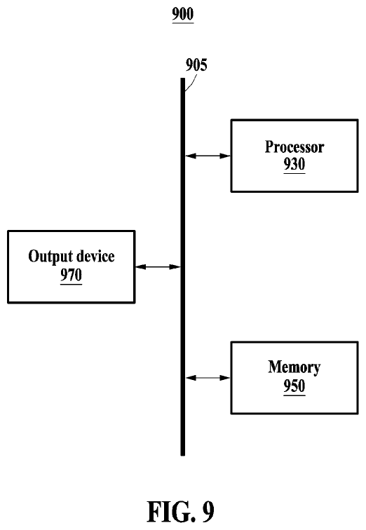

For ease of description, it is described that operations 110 to 140 are performed by an electronic device 900 (e.g., a simulation apparatus) illustrated in FIG. 9. Additionally, operations 110 to 140 may be described in detail with reference to FIGS. 2 to 8. However, operations 110 to 140 may also be performed by another suitable electronic device in a suitable system.

Furthermore, the operations shown in FIG. 1 may be performed in the shown order and manner. However, the order of some operations may change, or some operations may be omitted without departing from the spirit and scope of the shown embodiment. The operations shown in FIG. 1 may be performed in parallel or simultaneously.

A processor (e.g., a processor 930 of FIG. 9) may control the overall operation of the electronic device 900. In an embodiment, the processor 930 may be implemented as an array of a plurality of logic gates or may be implemented as a combination of a general-purpose microprocessor and a memory in which a program executable by the microprocessor is stored. In addition, it is to be understood by one of ordinary skill in the art to which the disclosure pertains that it may be implemented in other types of hardware.

Referring to FIG. 2, three-dimensional (3D) garments and two-dimensional (2D) patterns may be configured as a mesh 200 including a plurality of polygons. According to embodiments, the mesh 200 may be modeled in various manners. For example, the vertices of a polygon included in the mesh 200 may be point masses, and the sides of a polygon may be represented as elastic springs which connect the point masses. Thus, a 3D garment according to an embodiment may be modeled by a mass-spring model, for example. Springs may have respective resistance values against, for example, stretch, shear, and bending, depending on a physical property of the fabric used.

Alternatively, the mesh 200 may be modeled by a strain model. A polygon included in the mesh 200 may be modeled, for example, as a triangle as shown in FIG. 2 or as a polygon having four or more sides. In some examples, when a 3D volume is required to be modeled, the mesh 200 may be modeled as a 3D polyhedron.

The vertices of the polygon(s) included in the mesh 200 may be moved by an external force such as gravity and an internal force such as stretch, shear, and bending. When a force being applied to each vertex is obtained by calculating the external force and the internal force, a displacement rate and movement of each vertex may be obtained. Movements of a garment may be simulated through the movements of the vertices of the polygon(s) forming the mesh 200 in each time step.

For example, when a garment configured as the polygonal mesh 200 is draped over a 3D avatar, a natural 3D virtual garment based on the law of physics may be implemented. The vertices of the polygon(s) included in the mesh 200 may move according to the reaction of an external force such as gravity and the reaction of an internal force such as stretch, shear, and bending. When a force being applied to each vertex is obtained by calculating the external force and the internal force, the rate of movement and displacement of each vertex may be obtained. Also, the movement of a virtual garment may be simulated through movements of the vertices of the polygons of the mesh 200 in each time step. When a 2D pattern formed of the polygonal mesh 200 is draped over a 3D avatar, a 3D virtual garment in a natural look based on the law of physics may be implemented.

The 3D garments according to an embodiment may include, for example, at least one of a virtual garment that fits a body size of a user, a virtual garment for a 3D virtual character, and a virtual garment for a 3D virtual avatar.

The 3D garment may be generated by joining, or “sewing”, one of the outlines of a 2D pattern to one of the outlines of another 2D pattern. The sewing of a virtual garment may be implemented by connecting one of the outlines included in the mesh 200 of a 2D pattern with one of the outlines included in the mesh 200 of another 2D pattern. More specifically, on an outline of the two 2D patterns, polygonal vertices of the mesh 200 forming the 2D patterns may exist. In this case, when the processor 930 receives an input for an outline and length (“sewing line”) for which sewing is to be set, sewing of the virtual garment may be implemented by welding polygonal vertices of the mesh 200 positioned on the sewing line in each 2D pattern. That is, in a 3D virtual garment simulation, in order for patterns represented by the mesh 200 to be sewn, the number of polygons and sides included in the mesh 200 may have to be in contact with each other to form a sewing line.

In operation 110, the processor 930 according to an embodiment may receive a first selection input of a user for a sewing line 320 between patterns (e.g., a small pattern 310 and a large pattern 330) in a 3D virtual garment. The first selection input of the user may refer to the user clicking on a sewing line in the 3D virtual garment to edit the sewing line 320.

For ease of description, the size of the patterns in the described embodiments are expressed as different sizes, but are not limited to the described embodiments. The sewing between patterns may include 1) sewing between patterns of the same size and shape, 2) sewing between patterns of different sizes or shapes but with the same length of the sewing line 320, and 3) sewing between patterns of different sizes or shapes and with different lengths of the sewing line 320. The patterns may be sewn one-to-one as illustrated in the drawings, but are not limited to the described embodiments, and three or more patterns may be sewn in duplicate or in different directions to express the design of the garment. For example, two small patterns may be connected and sewn to one large pattern. In addition, the sewing line 320 may be modified depending on a sewing position for each pattern, and may appear to be the same length when the actual garment is sewn, but when the pattern is spread out and expressed as shown in the drawing, the length may be different for each pattern. That is, the length of the sewing line 320 may be changed depending on the sewing method.

In an embodiment, the processor 930 may receive a first selection input of the user for the sewing line 320 from the user, and display a sewing relationship according to visual depth for stepwise displaying a plurality of patterns hierarchically included in a 3D virtual garment. For example, when the top of a 3D virtual garment is a T-shirt, the pattern may include a front torso pattern, a back torso pattern, an arm sleeve pattern, and the like.

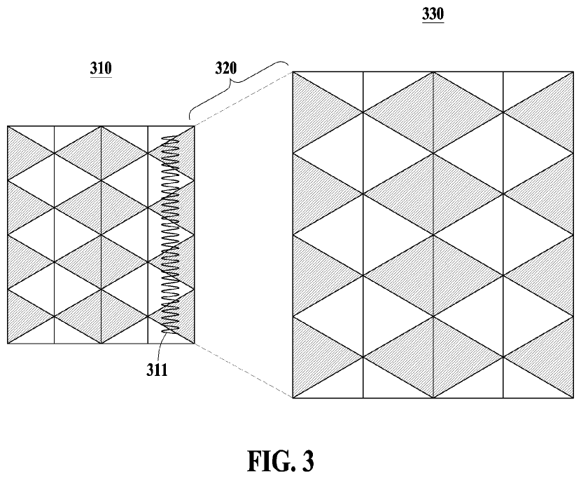

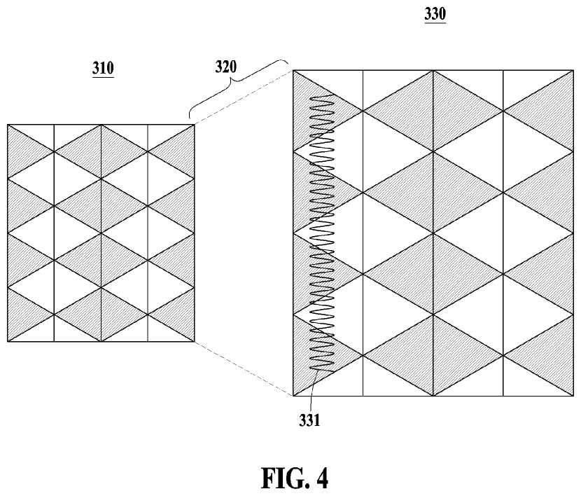

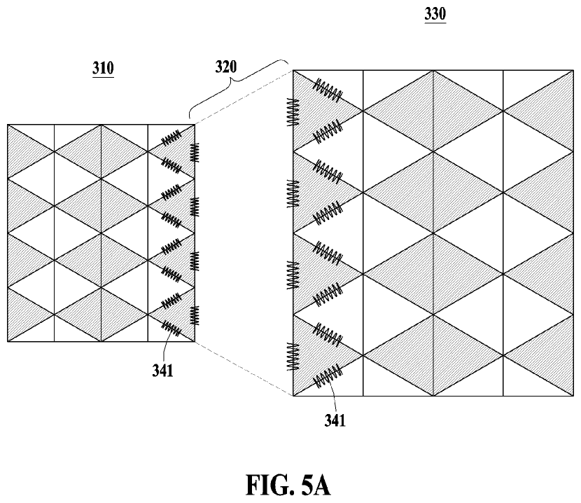

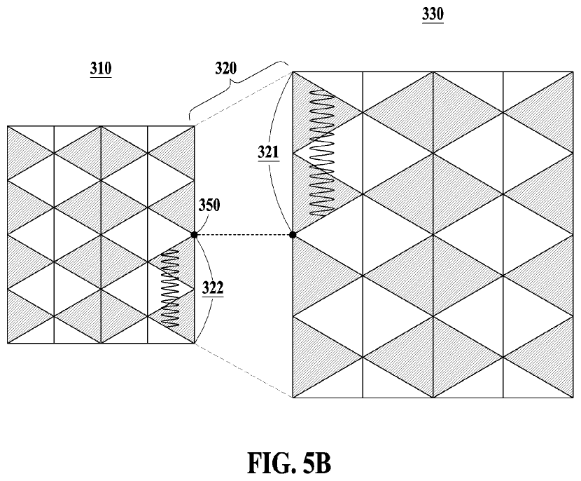

The processor 930 according to an embodiment may generate a sewing relationship by using an exploded view (e.g., ease sewing 301 of FIG. 3, stretch sewing 302 of FIG. 4, and an exploded view 500 of FIG. 5) adjusted so that a distance between at least one pattern and at least one other pattern among a plurality of patterns is increased based on visual depth. The exploded view may be a drawing in which a plurality of patterns included in a 3D virtual garment are exploded and separated from each other in a 3D virtual garment simulation. For example, in the exploded view, the processor 930 may adjust a distance between the patterns so that the distance between the patterns becomes further apart. Through this adjustment, users may perform detailed work on adjusting pattern properties, such as conversion of the sewing line 320, materials, and measurements, for each pattern included in the patterns of a 3D virtual garment design image.

In operation 120, the processor 930 according to an embodiment may receive a second selection input of the user for at least one of the ease sewing (e.g., the ease sewing 301 of FIG. 3) and stretch sewing (e.g., the stretch sewing 302 of FIG. 4) for the sewing line 320. The second selection input of the user may be the user selecting the sewing line 320 on a 3D virtual garment to edit the sewing line 320, and then selecting on the interface whether to perform the ease sewing 301 or stretch sewing 302 on the sewing line 320.

According to an embodiment, the ease sewing 301 may be sewing by gathering the large pattern 330 to fit the small pattern 310. In general, the ease sewing 301 may be performed on an armhole portion of the top of a garment.

The stretch sewing 302 according to an embodiment may be sewing by stretching the small pattern 310 to fit the large pattern 330. In general, the stretch sewing 302 may be frequently performed on the neckband, hems, or the like of the top of the garment.

Therefore, in order to simulate a natural garment shape in the 3D virtual garment simulation, the ease sewing 301 and the stretch sewing 302 may need to be implemented naturally.

In operation 130, the processor 930 according to an embodiment may adjust the mesh 200 properties of a sewing area adjacent to the sewing line 320, based on the second selection input of the user.

In general, real fabrics have elasticity. In a 3D virtual garment simulation, the elasticity of real fabric is implemented through a mesh, and the elasticity of real fabric may be maintained in an extended or contracted state depending on the sewing method. Therefore, in the 3D virtual garment simulation, mesh properties may need to be adjusted to implement elasticity similar to reality. Mesh properties may vary depending on how the mesh is implemented, but the described embodiment assumes a mass-spring model. Accordingly, adjusting the mesh properties may be adjusting coefficients of a mass-spring model of the polygons of the mesh or changing positions of the vertices of the polygons.

In the ease sewing 301, the processor 930 may insert a virtual spring or provide elasticity to a sewing area (e.g., a sewing area of the small pattern 310) of a pattern including a short sewing line so that a length of the sewing line 320 is biased toward a length of the short sewing line (e.g., a length of the small pattern 310) among the patterns. For example, the ease sewing 301 may include causing a sewing line to be biased toward the length of the short sewing line, and may include causing a sewing line to be biased toward the length of the short sewing line when a virtual spring having a length corresponding to a ratio of the length of the short sewing line is inserted into the short sewing line. Accordingly, when the processor 930 receives a selection input for the second selection input of the user for the ease sewing 301, the processor 930 may change the properties of the polygons of the sewing area of the pattern including a short sewing line (e.g., the sewing area of the small pattern 310) among the patterns, and change the properties of the polygons of a sewing area of the remaining pattern (e.g., the large pattern 330) among the patterns, in response to the change in the properties of the polygons of the sewing area of the pattern including the short sewing line among the patterns.

In the stretch sewing 302, the processor 930 may insert a virtual spring or provide elasticity to a sewing area of a pattern including a long sewing line (e.g., a sewing area of the large pattern 330) so that a length of the sewing line 320 is biased toward a length (e.g., a length of the large pattern 330) of the long sewing line among the patterns. For example, the stretch sewing 302 may include causing a sewing line to be biased in the length of the long sewing line, and may include causing a sewing line to be biased in the length of the long sewing line when a virtual spring having a length corresponding to a ratio of the length of the long sewing line is inserted into the long sewing line. Accordingly, when the processor 930 receives a selection input for the stretch sewing 302 in the second selection input of the user, the processor 930 may change the properties of the polygons in a sewing area of a pattern including a long sewing line (e.g., a sewing area of the large pattern 330) among the patterns, and change the properties of the polygons in the remaining pattern (e.g., the small pattern 310) among the patterns, in response to the change in the properties of the polygons in the sewing area of the pattern including the long sewing line among the patterns.

The processor 930 according to an embodiment may insert a virtual spring into a sewing area of patterns sewn by the sewing line 320 and change the properties of the polygons included in the sewing area into which the virtual spring is inserted. In response to the changes in the properties of the polygons, the processor 930 may express an effect on the patterns to appear as if ironing has been performed on the sewn patterns.

Hereinafter, the changes in the properties of the polygons is described.

The processor 930 according to an embodiment may insert one or more virtual springs into a sewing area of at least one pattern among the patterns in a sewing area. In response to a third selection input of the user, the ratio and stiffness of a virtual spring may be adjusted. Stiffness may be expressed as the strength of a virtual spring. The strength of a virtual spring may generally refer to an ability to withstand deformation or support a load. The stiffness in a virtual spring primarily measures a force required to deform the spring, which may be a resistance of the spring to deformation. The ratio of a virtual spring may generally refer to length, and the longer the length, the more easily the spring may deform.

That is, a virtual spring may be inserted into either of two patterns (or sewing lines) to provide tension. The stiffness of a virtual spring is its elastic modulus, where the stronger the stiffness, the greater the tension the virtual spring may have for the same ratio (or length of the virtual spring).

More specifically, the “ratio” may be converted into the elastic modulus of the virtual spring. Referring to Equation 1 below, a ratio of the virtual spring provided to the user may express a length of the virtual spring corresponding to a length of a reference sewing line according to the sewing method.

For example, when the sewing method is the ease sewing 301, a short sewing line may be used as a reference, based on the small pattern 310. Accordingly, the processor 930 may set a reference value of a ratio that makes the length of the short sewing line 100%. When the user adjusts the ratio to 70%, the length of the virtual spring may be adjusted to 70% of the length of the short sewing line. As the length of the virtual spring is shortened, the tension may increase depending on the characteristics of the spring. On the other hand, in the ease sewing 301, when the user adjusts the ratio to 200%, the length of the virtual spring may be adjusted to 200% of the length of the short sewing line. In this case, the tension may be weakened depending on the characteristics of the spring.

In another example, when the sewing method is the stretch sewing 302, a long sewing line may be used as a reference based on the large pattern 330. Accordingly, the processor 930 may set a reference value of a ratio that makes the length of the long sewing line 100%. When the user adjusts the ratio to 70%, the length of the virtual spring may be adjusted to 70% of the length of the long sewing line. As the length of the virtual spring is shortened, the tension may increase depending on the characteristics of the spring. On the other hand, in the stretch sewing 302, when the user adjusts the ratio to 200%, the length of the virtual spring may be adjusted to 200% of the length of the long sewing line. In this case, the tension may be weakened depending on the characteristics of the spring.

The described embodiment has been described with the small pattern 310 and the large pattern 330 for ease of description, but is not limited thereto. When the ease sewing 301 or stretch sewing 302 is performed between the same pattern, not between the small pattern 310 and the large pattern 330, but between sewing lines of the same size or length, the length of the reference sewing lines may be the same.

That is, the stiffness, strength and ratio of the spring may be used to adjust the tension of the spring, and the user may express the ease sewing 301 or stretch sewing 302 on a 3D virtual garment by adjusting the characteristics of the virtual spring. A third selection input of the user may be performed on an interface for adjusting a ratio or stiffness of the virtual spring. For example, the interface may provide a bar-type interface or a numeric input interface that adjusts the ratio or stiffness.

The virtual spring may not actually be inserted into the garment, but rather may be a tool for easily simulating changes due to external force applied when sewing. That is, the user may set a ratio (e.g., the length of the spring compared to the small pattern 310) and a stiffness (e.g., a degree to which the spring resists external force) of the virtual spring, and the processor 930 may perform a simulation according to the set virtual spring to display results of the ease sewing 301 and the stretch sewing 302 to the user.

A sewing area adjacent to the sewing line 320 may be an area where the properties of the polygons adjacent to the virtual spring among the polygons included in the mesh change as the ratio or stiffness of the virtual spring is adjusted. As the virtual spring is adjusted, a degree to which the virtual spring affects the small pattern 310 and the large pattern 330 may vary. That is, a pattern is such that the polygons of the mesh are affected by external force, and physical properties (e.g., positions of vertices when the polygons are mass-spring models) of the polygons may change.

Referring to FIG. 3, the processor 930 may insert a first virtual spring 311 into the small pattern 310 to simulate the ease sewing 301. The processor 930 may insert the first virtual spring 311 having a predetermined ratio and stiffness according to physical properties of a fabric to be implemented in a 3D virtual garment and a difference in size between the small pattern 310 and the large pattern 330. The processor 930 may insert an initial ratio and initial stiffness of the first virtual spring 311 by setting the initial ratio and initial stiffness to arbitrary values (or experimental values). Here, the arbitrary value may be set as a dominant value regardless of the type of pattern. For example, when the pattern is cotton, a predetermined initial ratio and initial stiffness of the first virtual spring 311 may be set to have a ratio of 0.9 for the vertical length of the small pattern 310 and a value 10 times the general stiffness value of cotton, thereby setting the first virtual spring 311 to be a virtual spring dominant to the fabric.

The processor 930 may receive an input of a user and adjust the ratio or stiffness of the first virtual spring 311. For example, the user may directly adjust the ratio of the first virtual spring 311 that has a ratio of 0.8 to 0.9. Alternatively, when an input that reduces the elasticity of the first virtual spring 311 is performed, a virtual spring that is 0.9 times the vertical length of the small pattern 310 may be implemented. However, as described above, this does not mean that the first virtual spring 311 is displayed in the simulation, but rather that the processor 930 simulates an effect as if the first virtual spring 311 is inserted.

Referring to FIG. 4, the processor 930 may insert a second virtual spring 331 into the small pattern 310 to simulate the stretch sewing 302. The processor 930 may insert the second virtual spring 331 having a predetermined ratio and stiffness according to physical properties of a fabric to be implemented in a 3D virtual garment and a difference in size between the small pattern 310 and the large pattern 330. The processor 930 may insert an initial ratio and initial stiffness of the second virtual spring 331 by setting the initial ratio and initial stiffness to arbitrary values (or experimental values). Here, the arbitrary value may be set as a dominant value regardless of the type of pattern. For example, when the pattern is cotton, a predetermined initial ratio and initial stiffness of the second virtual spring 331 may be set to have a ratio of 0.9 for the vertical length of the large pattern 330 and a value 10 times the general stiffness value of cotton, thereby setting the second virtual spring 331 to be a virtual spring dominant to the fabric.

Similarly, the processor 930 may receive an input of the user and adjust the ratio or stiffness of the second virtual spring. For example, the user may directly adjust the ratio of the second virtual spring 331 that has a ratio of 0.9 to 0.8. Alternatively, when the user performs an input that increases the elasticity of the second virtual spring 331, a virtual spring that is 0.8 times the vertical length of the large pattern 330 may be implemented. However, as described above, this does not mean that the second virtual spring 331 is displayed in the simulation, but rather that the processor 930 simulates an effect as if the second virtual spring 331 is inserted.

The first virtual spring 311 and the second virtual spring 331 described above are shown as one for ease of description, but are not limited to the described embodiment, and two or more virtual springs may be inserted for various sewing simulations.

Referring to FIG. 5A, the processor 930 may perform polygon elasticity adjustment sewing 303. The processor 930 may adjust the elasticity of polygons of a mesh to simulate the ease sewing 301 and stretch sewing 302.

For example, the mesh of patterns may be implemented as a mass-spring model. In this example, each side forming the polygons may be considered to be modeled as a single spring. Therefore, to adjust the elasticity of each polygon, the processor 930 may insert third virtual springs 341 into each side of the polygons or directly adjust the elasticity of each side of the polygons.

A sewing area may vary depending on a degree of performance (e.g., an applied stiffness of the first virtual spring 311, the second virtual spring 331, and the third virtual springs 341) of the ease sewing 301 and the stretch sewing 302. For example, when the ease sewing 301 is performed strongly, the large pattern 330 may be strongly dependent on the small pattern 310. In this example, when the ease sewing 301 is performed strongly, the influence of the ease sewing 301 may extend to a further area from the sewing line 320 of the patterns than when the ease sewing 301 is performed weakly. Accordingly, a degree of deformation of the mesh of the patterns may occur more strongly, and the processor 930 may calculate the degree of deformation of the mesh and reflect the calculated degree of deformation in a 3D virtual garment simulation.

In operation 140, the processor 930 according to an embodiment may simulate a 3D virtual garment to which the adjusted mesh properties are applied.

The above-described operations are described as performing only one of the ease sewing 301 or stretch sewing 302 on the sewing line 320. However, in actual garment designs, when sewing between patterns, the ease sewing 301 or stretch sewing 302 may be performed multiple times with different ratios and stiffness or may be performed in a complex manner, so that various garment designs may be expressed. Accordingly, a simulation apparatus may perform a plurality of the ease sewings 301 or stretch sewings 302 by applying the aforementioned operations in combination to the sewing line 320 to express various garment designs. The processor 930 may perform combination sewing 304 that performs the ease sewing 301 or stretch sewing 302 multiple times.

Referring to FIG. 5B, the processor 930 according to an embodiment may receive a fourth selection input of a user and generate a notch 350 in the sewing line 320. Here, the fourth selection input of the user may include a selection input for distinguishing the sewing line 320, and may include an input for dividing the sewing line 320 into two or more sewing lines. The processor 930 may receive a sewing generation input of the user for the sewing line 320 using the ease sewing 301 or the stretch sewing 302, based on the notch 350. The processor 930 may, in response to receiving the sewing generation input, generate a combination of ease sewing or stretch sewing on a sewing line based on a position of the notch 350 generated on the sewing line.

When the processor 930 generates the notch 350 on the sewing line 320 (the sewing line of the small pattern 310 and the large pattern 330) already generated on a 3D virtual garment and performs a plurality of sewing operations based on the notch 350, the ease sewing 301 or the stretch sewing 302 may be formed between a portion of the sewing line of the small pattern and a portion of the sewing line of the large pattern.

More specifically, originally, the sewing lines 320 of the small pattern 310 and the large pattern 330 may meet 1:1 to form a sewing, so that tension is uniformly applied to the spring of the small pattern 310 or the large pattern 330, and the mesh properties may be modified. On the other hand, when the sewing line 320 is divided by the notch 350 to perform multiple sewing, the processor 930 may perform simulation such that a plurality of tensions may be applied on one sewing line 320. Here, the processor 930 does not perform sewing by overlapping the sewing line 320 on which multiple sewing has already been generated, but rather divides (or separates) one sewing line 320 by the notch 350 so that the tension (or sewing method) applied to a first portion 321 of the sewing line 320 and the tension (or sewing method) applied to a second portion 322 of the sewing line 320 are set to be different.

For example, a user may perform the ease sewing 301 on half of the sewing line 320 and the stretch sewing 302 on the other half. The processor 930 may receive a first selection input from the user and generate the notch 350 on the sewing line 320. The notch 350 may be generated on the sewing line 320 and may be a vertex indicated on the sewing line 320 so that the user may arbitrarily separate the sewing line 320 and perform different sewing. The notch 350 may be generated at a vertex of a polygon on the sewing line 320, but when the user performs an input to generate the notch 350 at a position other than a vertex, the polygon may be deformed to generate a natural mesh shape. The processor may form a plurality of sewing lines by separating the sewing line 320 according to the generated notch 350. The processor 930 may receive a second selection input of the user for the ease sewing 301 or stretch sewing 302 that the user desires to perform on each of the plurality of formed sewing lines, and may perform the ease sewing 301 or stretch sewing 302 on each of the sewing lines. Based on the notch 350 generated on the sewing line 320, when the user performs the ease sewing 301 or stretch sewing 302, the processor 930 may simulate a 3D virtual garment with a combination of the ease sewing 301 or the stretch sewing 302. That is, rather than one sewing method being performed on one sewing line 320, dividing points are generated on one sewing line 320, and based on the dividing points, the user may combine desired sewing methods in various ways, and accordingly, a 3D virtual garment may be simulated with various designs. A method of performing the ease sewing 301 or stretch sewing 302 on respective portions may be performed separately by operations 110 to 140 described above.

FIG. 2 is a diagram schematically illustrating a mesh according to an embodiment.

Referring to FIG. 2, in an embodiment, for ease of description, an example is provided in which the mesh 200 includes triangles, but the embodiment is not necessarily limited thereto, and depending on embodiments, the mesh 200 may be modeled by polygons of various shapes.

In an embodiment, the mesh 200 may be modeled in various forms. For example, a vertex of a polygon included in the mesh 200, or in other words, the vertices of the polygon, may be point masses. The sides of the polygons included in the mesh 200 may be expressed as springs with elasticity that connect the point masses. Thus, a 3D model of a garment according to an embodiment may be modeled by a mass-spring model. For example, the springs may have respective resistance values against stretch, shear, and bending, depending on a physical property of the fabric used. Alternatively, the mesh 200 may be modeled by a strain model. As another example, a polygon included in the mesh 200 may be modeled as a triangle or as a polygon having four or more sides. When a 3D volume is required to be modeled, the mesh 200 may be modeled as a 3D polyhedron. The 3D model of the garment according to an embodiment may include at least one of a virtual garment for a 3D virtual character and a virtual garment for a 3D virtual avatar.

FIGS. 3 to 5 are schematic diagrams illustrating a sewing method according to an embodiment.

FIGS. 3 to 5 are exemplary exploded views illustrating sewing simulations, briefly representing meshes of the small pattern 310, the sewing line 320, and the large pattern 330. In the exploded view, the sewing line 320 may be shared by the small pattern 310 and the large pattern 330. A length of the sewing line 320 may vary depending on the sewing method. For example, in the case of the ease sewing 301, a length of the sewing line 320 may be similar to a vertical length of the small pattern 310. On the other hand, in the case of the stretch sewing 302, a length of the sewing line 320 may be similar to a vertical length of the large pattern 330.

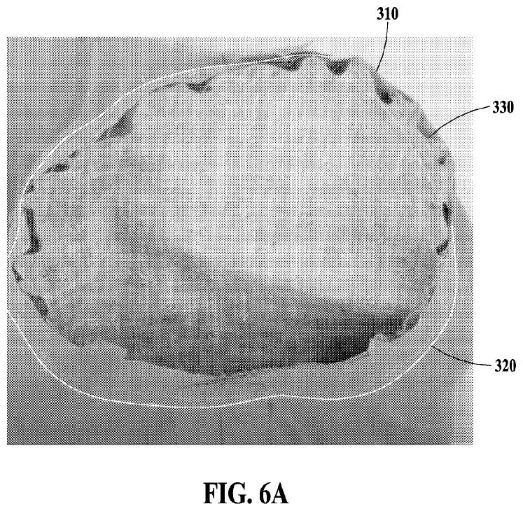

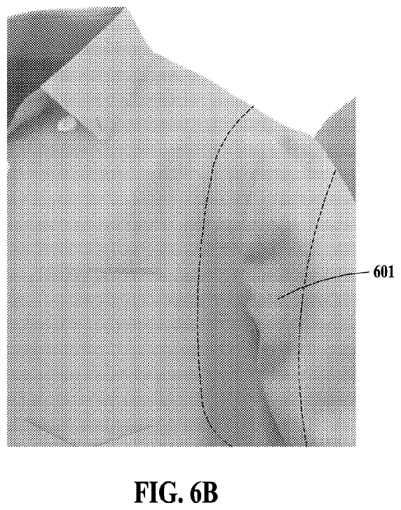

FIGS. 6A and 6B are diagrams schematically illustrating sewing simulations according to an embodiment.

The description provided with reference to FIGS. 1 to 5 may also apply to FIGS. 6A and 6B, and any repeated description related thereto may be omitted.

FIG. 6A is a cross-section simulating a result of ease sewing 301 the large pattern 330 to the small pattern 310. FIG. 6B is a diagram simulating a result of ease sewing 301 the large pattern 330 to the small pattern 310 in an armhole of a 3D virtual garment. Referring to FIG. 6A, the large pattern 330 appears to be crumpled into the small pattern 310. Similarly, referring to FIG. 6B, wrinkles are formed in an armhole portion of a top garment. That is, as a result of the ease sewing 301, the inside of the armhole is sewn with the large pattern 330 in wrinkles, and some ease wrinkles 601 are generated near the sewing line 320.

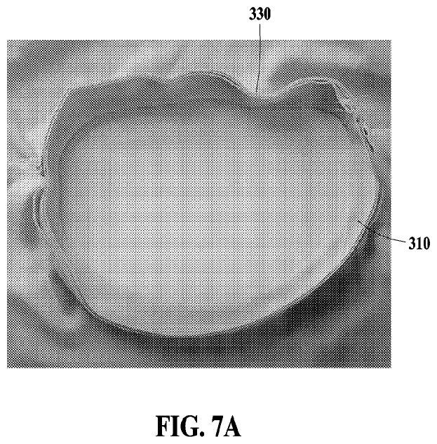

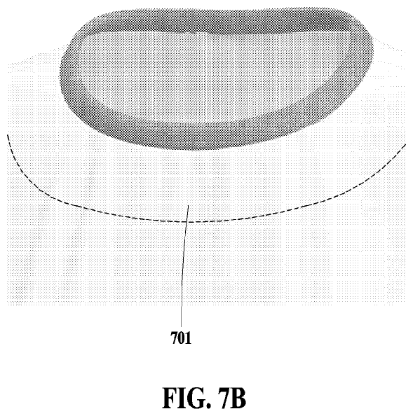

FIGS. 7A and 7B are diagrams schematically illustrating sewing simulations according to an embodiment.

FIG. 7A is a cross-section of a simulation of a state of stretch sewing 302 the small pattern 310 to the large pattern 330. FIG. 7B is a diagram of a simulation of a state of stretch sewing 302 the small pattern 310 to the large pattern 330 in a neckband of a 3D virtual garment. Referring to FIG. 7A, the small pattern 310 is sewn and stretched onto the large pattern 330. Similarly, referring to FIG. 7B, wrinkles are formed on the neckband of the top of the garment. That is, as a result of the stretch sewing 302, the inside of the neckband is sewn with the small pattern 310 stretched, and some stretch wrinkles 701 are generated near the sewing line 320.

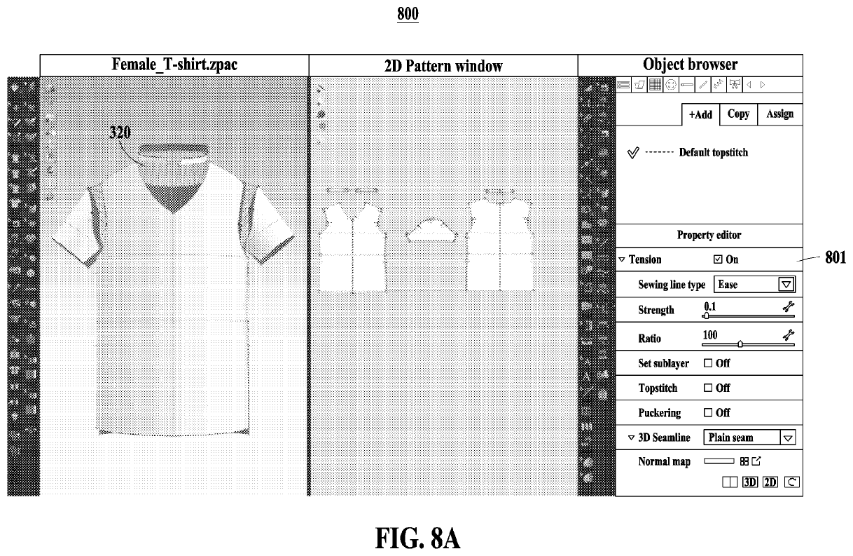

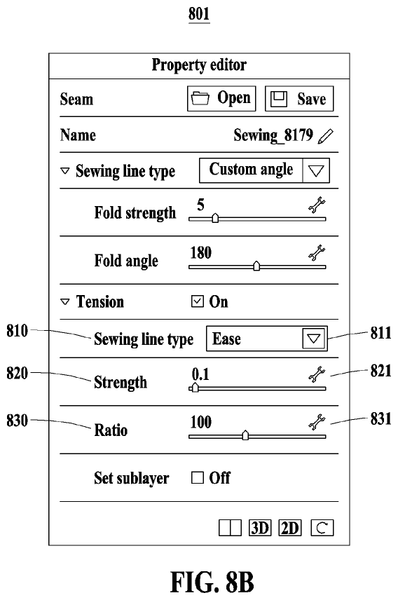

FIGS. 8A and 8B are diagrams schematically illustrating a user interface according to an embodiment.

The description provided with reference to FIGS. 1 to 7B may also apply to FIGS. 8A and 8B, and any repeated description related thereto may be omitted.

A user interface 800 according to an embodiment is a screen provided to a user that may simulate a 3D virtual garment, provide visual depth for sewing lines, and display pieces of patterns for easy garment editing by the user. Additionally, the user interface 800 may provide editing tools on the left and right to assist the user in editing a garment.

Referring to FIGS. 8A and 8B, the processor 930 according to an embodiment may, in response to receiving a first selection input for the sewing line 320 on the user interface 800, display to a user through an output device a property editor interface 801 for adjusting properties of the sewing line 320.

The property editor interface 801 according to an embodiment may include type interfaces 810 and 811 for receiving inputs for ease sewing and stretch sewing, strength (or stiffness) interfaces 820 and 821 for adjusting the stiffness of an inserted virtual spring, and ratio interfaces 830 and 831 for adjusting the ratio of an inserted virtual spring. The ratio interface 831 may be displayed in % form (0 to 100%) or decimal form.

In an embodiment, the processor 930 may display, on the property editor interface 801, the type interfaces 810 and 811 for receiving a second selection input of the user for at least one of the ease sewing 301 and the stretch sewing 302. The processor 930 may display the interfaces 820, 821, 830 and 831 for receiving a third selection input of the user, which is an adjustment input for the ratio or stiffness of a virtual spring. The third selection input of the user may be to adjust the properties of the virtual spring by inputting numbers in the strength (or stiffness) interfaces 820 and 821 and the ratio interfaces 830 and 831. However, the method of adjusting the properties of the virtual spring is not limited to numeric input, and a bar-shaped scroll may be provided to allow the user to easily adjust the properties of the virtual spring.

In an embodiment, the processor 930 may display a sewing area adjacent to the sewing line 320 in response to the second selection input of the user, and the third selection input of the user, which is an adjustment input for the ratio or stiffness of the virtual spring.

The indications for a sewing area may be described with reference to FIGS. 6A to 7B. For example, when ease sewing is performed, the ease wrinkles 601 may be generated near the armhole sewing line as shown in FIG. 6B. In this example, a portion where the ease wrinkles 601 are generated may be defined as a sewing area. Likewise, when stretch sewing is performed, the stretch wrinkles 701 may be generated near the neckband sewing line as shown in FIG. 7B. In this example, a portion where the stretch wrinkles 701 are generated may be defined as a sewing area. Accordingly, since the ease wrinkles and stretch wrinkles are generated by deformation of the properties of the polygons of the mesh, an area affected by ease sewing and stretch sewing may be considered as the sewing area.

FIG. 9 is a block diagram of an electronic device according to an embodiment.

Referring to FIG. 9, an electronic device 900 (e.g., a terminal or a server) according to an embodiment may include the processor 930, a memory 950, and an output device 970 (e.g., a display). The processor 930, the memory 950, and the output device 970 may be connected to one another through a communication bus 905. For ease of description, it may be assumed that at least one of the above-described methods or an algorithm corresponding to at least one of the methods is performed by one or more processors 930.

The output device 970 may display a user interface for a sewing simulation provided by the processor 930.

The memory 950 may store information on sewing relationships, ease sewing, and stretch sewing related to a sewing simulation performed by the processor 930. Further, the memory 950 may store various pieces of information generated in the processing of the processor 930 described above. In addition, the memory 950 may store a variety of data and programs. The memory 950 may include, for example, a volatile memory or a non-volatile memory. The memory 950 may include a high-capacity storage medium, such as a hard disk, to store a variety of data.

In addition, the processor 930 may perform at least one of the methods described above with reference to FIGS. 1 to 8 or an algorithm corresponding to at least one of the methods. In the above-described process, the processor 930 is described as being included in the electronic device 900, but the processor 930 may be included in a server that performs the sewing simulation. The processor 930 may be a data processing device implemented by hardware including a circuit having a physical structure to perform desired operations. The desired operations may include, for example, code or instructions included in a program. The processor 930 may be implemented as, for example, a central processing unit (CPU), a graphics processing unit (GPU), or a neural network processing unit (NPU). For example, a hardware-implemented electronic device 900 may include, for example, a microprocessor, a CPU, a processor core, a multi-core processor, a multiprocessor, an application-specific integrated circuit (ASIC), and a field programmable gate array (FPGA).

The processor 930 may execute a program and control the electronic device 900. Program code to be executed by the processor 930 may be stored in the memory 950.

The embodiments described herein may be implemented using a hardware component, a software component and/or a combination thereof. A processing device may be implemented using one or more general-purpose or special-purpose computers, such as, for example, a processor, a controller, an arithmetic logic unit (ALU), a digital signal processor (DSP), a microcomputer, an FPGA, a programmable logic unit (PLU), a microprocessor or any other device capable of responding to and executing instructions in a defined manner. The processing device may run an OS and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combinations thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A three-dimensional (3D) virtual garment simulation method, comprising:
receiving a first selection input for a sewing line between patterns in a 3D virtual garment;
receiving a second selection input for at least one of ease sewing and stretch sewing for the sewing line;
adjusting mesh properties of a sewing area adjacent to the sewing line, based on the second selection input; and
simulating the 3D virtual garment applied with the adjusted mesh properties.

2. The 3D virtual garment simulation method of claim 1, wherein the adjusting of the mesh properties comprises:
inserting one or more virtual springs into a sewing area of at least one pattern of the patterns in the sewing area.

3. The 3D virtual garment simulation method of claim 2, wherein the virtual spring is adjusted in ratio or stiffness in response to a third selection input.

4. The 3D virtual garment simulation method of claim 3, wherein the sewing area adjacent to the sewing line is an area in which properties of polygons adjacent to the virtual spring of polygons included in a mesh change as the ratio or stiffness of the virtual spring is adjusted.

5. The 3D virtual garment simulation method of claim 2, wherein the ease sewing is a sewing that inserts the virtual spring or provides elasticity to a sewing area of a pattern comprising a short sewing line so that a length of the sewing line is biased to a length of the short sewing line of the patterns.

6. The 3D virtual garment simulation method of claim 5, wherein the adjusting of the mesh properties comprises:
when a selection input for the ease sewing is received in the second selection input, in response to a change in properties of polygons of the sewing area of the pattern comprising the short sewing line of the patterns, changing properties of polygons of the sewing area of remaining patterns of the patterns.

7. The 3D virtual garment simulation method of claim 2, wherein the stretch sewing is a sewing that inserts the virtual spring or provides elasticity to a sewing area of a pattern comprising a long sewing line so that a length of the sewing line is biased to a length of the long sewing line among the patterns.

8. The 3D virtual garment simulation method of claim 7, wherein the adjusting of the mesh properties comprises:
when a selection input for the stretch sewing is received in the second selection input, in response to a change in properties of polygons of the sewing area of the pattern comprising the long sewing line among the patterns, changing properties of polygons of the sewing area of remaining patterns of the patterns.

9. The 3D virtual garment simulation method of claim 1, further comprising:
displaying a property editor interface for adjusting properties of the sewing line in response to receiving the first selection input for the sewing line.

10. The 3D virtual garment simulation method of claim 9, further comprising:
displaying, on the property editor interface, an interface for receiving the second selection input for at least one of the ease sewing and the stretch sewing and an interface for receiving an adjustment input for a ratio or stiffness of a virtual spring; and
displaying a sewing area adjacent to the sewing line in response to the second selection input and the adjustment input for the ratio or stiffness of the virtual spring.

11. The 3D virtual garment simulation method of claim 1, further comprising:
receiving a fourth selection input and generating a notch in the sewing line; and
receiving a sewing generation input for the sewing line using the ease sewing or the stretch sewing, based on the notch.

12. The 3D virtual garment simulation method of claim 11, further comprising:
in response to receiving the sewing generation input, generating a combination of the ease sewing or the stretch sewing on the sewing line based on a position of the notch generated on the sewing line.

13. A non-transitory computer-readable storage medium storing instructions that, when executed by a processor, cause the processor to perform the 3D virtual garment simulation method of claim 1.

14. A simulation apparatus, comprising:
one or more processors;
an output device displaying a user interface; and
memory storing instructions thereon, the instructions when executed by the one or more processors cause the one or more processors to:
receive a first selection input for a sewing line between patterns in a three-dimensional (3D) virtual garment,
receive a second selection input for at least one of ease sewing and stretch sewing for the sewing line,
adjust mesh properties of a sewing area adjacent to the sewing line, based on the second selection input, and
simulate the 3D virtual garment applied with the adjusted mesh properties.

15. A server comprising:
a communication circuit configured to receive an input from a terminal for performing a sewing simulation and transmit a result of the performing of the sewing simulation;
one or more processors; and
memory storing instructions thereon, the instructions when executed by the one or more processors cause the one or more processors to:
receive a first selection input for a sewing line between patterns in a three-dimensional (3D) virtual garment,
receive a second selection input for at least one of ease sewing and stretch sewing for the sewing line,
adjust mesh properties of a sewing area adjacent to the sewing line, based on the second selection input, and
simulate the 3D virtual garment applied with the adjusted mesh properties.
